(19) United States
(12) Patent Application Publication
(10) Pub. No.: US 2007/0287033 A1
(43) Pub. Date: Dec. 13, 2007

(54) Magnetic recording medium

(75) Inventors: Yoshihiro Nakai, Kanagawa (JP); Hiroshi Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/808,175

(22) Filed: Jun. 7, 2007

(30) Foreign Application Priority Data
Jun. 9, 2006 (JP) 2006-161231

(51) Int. Cl. G11B 5/716

(52) U.S. Cl. 428/840.1; 428/840.5

(57) ABSTRACT

A magnetic recording medium is provided that comprises a non-magnetic support and, in order thereabove, a radiation-cured layer cured by exposing a layer comprising a radiation curing compound and a chain transfer agent to radiation, and a magnetic layer comprising a ferromagnetic powder dispersed in a binder.

### BACKGROUND OF THE INVENTION

1. Field of the Invention

The present invention relates to a magnetic recording medium suitable for high density recording.

2. Description of the Related Art

Magnetic recording technology has the excellent features, not seen in other recording methods, that the medium can be used repeatedly, signals are easily converted to electronic form and it is possible to build a system in combination with peripheral equipment, and signals can easily be corrected, and is therefore widely used in various fields including video, audio, and computer applications.

As tape-form magnetic recording media for audio, video, and computers, and disc-form magnetic recording media such as flexible discs, a magnetic recording medium has been used in which a magnetic layer having dispersed in a binder a ferromagnetic powder such as γ-iron oxide, Co-containing iron oxide, chromium oxide, or a ferromagnetic metal powder is provided on a support. With regard to the support used in the magnetic recording medium, polyethylene terephthalate (PET), polyethylene naphthalate (PEN), etc. are generally used. Since these supports are drawn and are highly crystallized, their mechanical strength is high and their solvent resistance is excellent.

Since the magnetic layer, which is obtained by coating the support with a coating solution having the ferromagnetic powder dispersed in the binder, has a high degree of packing of the ferromagnetic powder, low elongation at break and is brittle, it is easily destroyed by the application of mechanical force and might peel off from the support. In order to prevent this, an undercoat layer is provided on the support so as to make the magnetic layer adhere strongly to the support.

In response to a demand for magnetic recording media with higher density recording, it is necessary to smooth the surface of the magnetic recording medium in order to further improve electromagnetic conversion characteristics. In the light of such issues, a magnetic recording medium has been proposed that has, above a non-magnetic support, a radiation-cured layer employing a monomer having a functional group that is cured by radiation such as an electron beam, that is, a radiation curing monomer (ref. JP-A-2005-267728, JP-A-2005-310311 and JP-A-2006-40472. JP-A denotes a Japanese unexamined patent application publication).

On the other hand, with regard to a magnetic recording medium produced by using a chain transfer agent, the following examples are known.

Patent Publication (JP-A-09-132749) proposes a magnetic recording medium formed by providing, above a non-magnetic support, a magnetic layer comprising a ferromagnetic powder in a binder, wherein the binder comprises as a main agent a modified copolymer obtained by reacting a vinyl chloride-based copolymer, obtained by copolymerization in the presence of an SH group-containing chain transfer agent and comprising as essential constituent components (A) a vinyl chloride unit and (B) a vinyl alcohol unit and/or a vinylic monomer unit having a hydroxyl group-containing organic group as a side chain, with a monomer having one ethylenically unsaturated double bond and one isocyanate group per molecule and not having a urethane bond in the molecule, and the magnetic layer is cured by exposure to radiation.

Patent Publication (JP-A-10-503543) proposes a polymer binder system useful for a magnetic recording medium, comprising (a) a hard resin component comprising a non-halogenated vinyl copolymer having a plurality of pendant nitrile groups, a plurality of pendant hydroxyl groups, and at least one pendant dispersing group and (b) a soft resin component comprising a polyurethane polymer comprising at least one pendant dispersing group such as a phosphonate diester group, and mercaptosuccinic acid is cited as an example of a functional chain transfer agent used when copolymerizing a vinyl monomer. Patent Publication (JP-A-2003-141710) proposes a magnetic recording medium comprising, in order above at least one surface of a non-magnetic support, a non-magnetic layer comprising a non-magnetic powder and a binder, and a magnetic layer comprising a binder and a ferromagnetic hexagonal ferrite powder as a ferromagnetic powder, wherein (1) the magnetic layer has a thickness of at least 0.01 μm but no greater than 0.20 μm, (2) the ferromagnetic hexagonal ferrite powder contained in the magnetic layer has an average plate size of 10 to 40 nm, (3) in electron beam microanalysis an intensity standard deviation b with respect to an average intensity a due to an element of the ferromagnetic hexagonal ferrite powder satisfies 0.03≦b/a≦0.4, and (4) the binder contained in the magnetic layer is a polyurethane resin comprising 0.2 to 0.7 meq/g of at least one type of polar group selected from —SO₃M, —OSO₃M, —PO(OM)₂, —OPO(OM)₂, and —COOM (M denotes a hydrogen atom, an alkali metal, or ammonium), and a mercapto compound having a polar group at one terminus is cited as an example of a chain transfer agent used when preparing the binder contained in the magnetic layer.

When a radiation curing monomer is used in a radiation-cured layer, a magnetic layer, etc., there is often the problem that in a radiation curing process, curing of the monomer used might be insufficient due to oxygen contained in the atmosphere, thus greatly affecting the production process or the product performance. In order to solve such a problem, a method in which the interior of the equipment is purged with nitrogen, which is an inert gas, for the purpose of cutting off the supply of oxygen, a method in which the amount of radiation applied to the radiation curing monomer is increased, etc. have been proposed. However, in a continuous production process it is very difficult in terms of facilities to purge the entire equipment with an inert gas and completely shut out oxygen inhibition, and since a large amount of inert gas is required, the cost burden is very great. A method in which the line speed is decreased in order to increase the amount of radiation applied to the radiation curing monomer has been carried out, but this method is undesirable since the productivity is reduced. Furthermore, a method in which the exposure to radiation by a radiation exposure system is increased has been carried out, but when the level of exposure increases, an effect on other components contained in the magnetic recording medium, such as the support used being degraded by radiation, might become a problem.

### BRIEF SUMMARY OF THE INVENTION

It is an object of the present invention to provide a magnetic recording medium having (1) excellent smoothness, (2) a low coefficient of friction, (3) excellent electromagnetic conversion characteristics and error characteristics, and (4) excellent transport durability and storage stability, and to provide a radiation-cured layer having (5) a low amount of residual monomer cured under an atmosphere with a high oxygen concentration.

The present inventors have found that the above-mentioned problems can be solved by a radiation-cured layer cured by exposing to radiation a layer comprising a radiation curing monomer and a chain transfer agent. That is, the problems to be solved by the present invention are solved by means of (1) below, which is described below together with (2) to (6), which are preferred embodiments.

### (1) A magnetic recording medium comprising, above a non-magnetic support, a radiation-cured layer cured by exposing a layer comprising a radiation curing monomer and a chain transfer agent to radiation,

(2) the magnetic recording medium according to (1), wherein it comprise, in order above the non-magnetic support, the radiation-cured layer, and a magnetic layer comprising a ferromagnetic powder dispersed in a binder,
(3) the magnetic recording medium according to (1), wherein it comprises, in order above the non-magnetic support, the radiation-cured layer, a non-magnetic layer comprising a non-magnetic powder dispersed in a binder, and a magnetic layer comprising a ferromagnetic powder dispersed in a binder,
(4) the magnetic recording medium according to any one of (1) to (3), wherein the chain transfer agent is a thiol compound having at least one thiol group and/or a disulfide compound having at least one —S—S— bond,
(5) the magnetic recording medium according to any one of (1) to (4), wherein the radiation curing monomer is an ethylenically unsaturated monomer, and
(6) the magnetic recording medium according to any one of (1) to (5), wherein the radiation-cured layer has a thickness of 0.1 to 1.5 μm.

### DETAILED DESCRIPTION OF THE INVENTION

The magnetic recording medium of the present invention comprises a non-magnetic support and, in order thereabove, a radiation-cured layer cured by exposing a layer comprising a radiation curing monomer and a chain transfer agent to radiation, and a magnetic layer comprising a ferromagnetic powder dispersed in a binder. Another aspect of the present invention relates to a process for producing a magnetic recording medium, this production process comprising a step of preparing a radiation-cured layer composition comprising a radiation curing monomer and a chain transfer agent, a step of providing the composition by coating above a non-magnetic support, a step of obtaining a radiation-cured layer by curing the coated composition by exposure to radiation, and a step of providing a magnetic layer comprising a ferromagnetic powder dispersed in a binder by coating above the radiation-cured layer. The radiation curing monomer is preferably an ethylenically unsaturated monomer. The chain transfer agent is preferably at least one compound selected from the group consisting of a thiol compound having at least one thiol group and a disulfide compound having at least one —S—S— bond. The exposure to radiation is preferably exposure to an electron beam. The present invention is explained in detail below.

### I. Radiation-Cured Layer

### 1. Radiation Curing Monomer

In the present invention, the radiation curing monomer is a low molecular weight compound that cures upon exposure to radiation such as UV rays or an electron beam. The radiation curing monomer is thermally stable in a state in which it is not exposed to radiation. Because of this, a coating solution containing the radiation curing monomer has appropriate viscosity when a coating solvent evaporates on a non-magnetic support, exhibits an effect in burying micro projections on the non-magnetic support, and can give high coating smoothness by curing. That is, the radiation-cured layer of the present invention plays a role as a smoothing layer.

As a radiation curing monomer used in the radiation-cured layer, a monomer having an ethylenically unsaturated group (hereinafter, called an ethylenically unsaturated monomer) is preferable, and a polyfunctional monomer containing at least two radiation curing functional groups per molecule is more preferable as one that gives scratch resistance to the layer surface and an effect in protecting the surface of a substrate. When a polyfunctional monomer is used the radiation-cured layer can give high coating strength due to a three-dimensional crosslinking reaction. As a radiation curing group, a (meth)acrylic group or a vinyl ether group is preferable, a (meth)acrylic group is more preferable, and an acrylic group is yet more preferable.

In the present invention, one or more types of the (meth)acrylates shown below may appropriately selected and used. ‘(Meth)acrylate’ has the meaning of both acrylate and methacrylate, and this applies to the following also.

For example, there are (meth)acrylate compounds obtained by reacting a polyhydric alcohol with a compound having a radiation curing functional group and a carboxylic acid represented by acrylic acid or methacrylic acid, and urethane acrylates obtained by reacting a polyhydric alcohol with a compound having a radiation curing functional group and a group that reacts with a hydroxyl group, represented by 2-isocyanatoethyl acrylate or 2-isocyanatoethyl methacrylate.

There are also those obtained by reacting a diisocyanate compound or an isocyanate terminal prepolymer with a compound having a radiation curing functional group and a group that reacts with an isocyanate group, represented by hydroxyethyl (meth)acrylate or hydroxybutyl (meth)acrylate. As the polyhydric alcohol, in addition to diols used as conventionally known polyurethane starting materials, polyester polyols, polyether polyols, polycarbonate polyols, polyolefin polyols, and polyether ester polyols may be used. As the diisocyanate compound, a known starting material for a polyurethane may be used.

Examples of polyfunctional (meth)acrylates that can be used in the present invention include, as difunctional compounds, 1,3-butanediol di(meth)acrylate, 1,4-butanediol di(meth)acrylate, 1,6-hexanediol di(meth)acrylate, diethylene glycol di(meth)acrylate, polyethylene glycol di(meth)acrylate, neopentyl glycol di(meth)acrylate, and cyclopentadienyl alcohol di(meth)acrylate. Examples of (meth)acrylates other than the above polyfunctional esters include polyester poly(meth)acrylates, epoxy (meth)acrylates, urethane poly(meth)acrylates, polysiloxane poly(meth)acrylates, and polyamide poly(meth)acrylates.

Examples of tri- or higher-functional polyfunctional (meth)acrylates include trimethylolpropane tri(meth)acrylate, trimethylolethane tri(meth)acrylate, ditrimethylolpropane tetra(meth)acrylate, glycerol tri(meth)acrylate, pentaerythritol tri(meth)acrylate, pentaerythritol tetra(meth)acrylate, dipentaerythritol penta(meth)acrylate, dipentaerythritol hexa(meth)acrylate, and ethylene oxide- or propylene oxide-modified products thereof.

The radiation-cured layer of the present invention may employ a known radiation curing monomer such as a (meth)acrylate compound described in ‘Teienerugi Denshisenshosha no Oyogijutsu’ (Application of Low-energy Electron Beam) (Published by CMC), ‘UV/EB Kokagijutsu’ (UV/EB Radiation Curing Technology) (published by the Sogo Gijutsu Center), etc.

Among them, a preferred ethylenically unsaturated monomer is a di- or higher-functional polyfunctional monomer, and as a functional group an acryloyl group is preferred to a methacryloyl group since the polymerizability is excellent.

Furthermore, as the ethylenically unsaturated monomer, an aliphatic diacrylate and an alicyclic diacrylate are preferable since a resulting magnetic recording medium has an excellent balance between mechanical strength and hygroscopicity.

Preferred examples of the aliphatic diacrylate include hexamethylenediol diacrylate, 2-ethyl-2-butyl-1,3-propanediol diacrylate, 3-methylpentanediol diacrylate, 2-methyloctanediol diacrylate, nonanediol diacrylate, neopentylglycol hydroxypivalate diacrylate, and a urethane diacrylate of trimethylhexamethylene diisocyanate.

Among them, from the viewpoint of a resulting radiation-cured layer having excellent smoothness, those having a branched side chain are preferable, and 2-ethyl-2-butyl-1,3-propanediol diacrylate, 3-methylpentanediol diacrylate, 2-methyloctanediol diacrylate, neopentylglycol hydroxypivalate diacrylate, and a urethane diacrylate of trimethylhexamethylene diisocyanate are more preferable.

Preferred examples of the alicyclic diacrylate include cyclohexanedimethanol diacrylate, limonene alcohol diacrylate, tricyclodecanedimethanol diacrylate, dimer diol diacrylate, 5-ethyl-2-(2-hydroxy-1,1′-dimethylethyl)-5-(hydroxymethyl)-1,3-dioxane diacrylate, tetrahydrofurandimethanol diacrylate, and 3,9-bis(1,1-dimethyl-2-hydroxyethyl)-2,4,8,10-tetraoxaspiro[5,5]undecane diacrylate. Among them, tricyclodecanedimethanol diacrylate is preferable.

Examples of (meth)acrylates other than the above polyfunctional esters include epoxy (meth)acrylates, polysiloxane poly(meth)acrylates, and polyamide poly(meth)acrylates.

The radiation curing monomer preferably has a molecular weight of 300 to 5,000. When the molecular weight is in the above-mentioned range, unreacted radiation curing ethylenically unsaturated monomer is not deposited on the surface of the radiation-cured layer or the magnetic recording medium, a coating solution has appropriate viscosity, and excellent smoothness can be obtained.

Furthermore, for reasons of adjusting viscosity, improving adhesion to a substrate, etc., a monofunctional (meth)acrylate may be added as necessary. Examples of such a monofunctional (meth)acrylate include 2-hydroxyethyl (meth)acrylate, 2-hydroxypropyl (meth)acrylate, 3-hydroxybutyl (meth)acrylate, 4-hydroxybutyl (meth)acrylate, 2-hydroxypentyl (meth)acrylate, 4-hydroxypentyl (meth)acrylate, 2-ethylhexyl (meth)acrylate, ethoxyethyl (meth)acrylate, N-hydroxymethyl (meth)acrylamide, and N-methoxymethyl (meth)acrylamide. The amount of these monofunctional (meth)acrylates used is preferably 0 to 40 parts by weight relative to 100 parts by weight of the solids content of the radiation-cured layer, and more preferably 0 to 30 wt % when scratch resistance, etc. are taken into account.

### 2. Chain Transfer Agent

The chain transfer agent used in the present invention is not particularly limited and may be any compound as long as it promotes a chain transfer reaction, and examples thereof include a thiol compound having at least one thiol group (—SH, also called a mercapto group) and a disulfide compound having at least one —S—S— bond. Among them, as a chain transfer agent that can be used in the present invention, a thiol compound and/or a disulfide compound are preferable, a thiol compound is more preferable, and a polyfunctional thiol compound having at least two thiol groups in the molecule is particularly preferable.

As the chain transfer agent that can be used in the present invention, various types of thiol compounds such as alkylmercaptans, mercaptoacetic acid esters, alkyl disulfides, and polyfunctional thiols can be cited. Specific preferred examples include monofunctional thiol compounds such as mercaptoacetic acid, 2-mercaptopropionic acid, 3-mercaptopropionic acid, methyl mercaptopropionate, octyl mercaptopropionate, methoxybutyl mercaptopropionate, tridecyl mercaptopropionate, thioglycolic acid, ammonium thioglycolate, monoethanolamine thioglycolate, sodium thioglycolate, methyl thioglycolate, octyl thioglycolate, methoxybutyl thioglycolate, 2-mercaptobenzothiazole, 2-mercaptobenzimidazole, 2-mercaptobenzoxazole, 3-mercapto-1,2,4-triazole, 2-mercapto-4(3H)-quinazoline, and β-mercaptonaphthalene, and polyfunctional thiol compounds such as 1,2-ethanedithiol, 1,3-propanedithiol, 1,4-butanedithiol, 1,6-hexanedithiol, 1,8-octanedithiol, 1,2-cyclohexanedithiol, decanedithiol, ethylene glycol bisthioglycolate, 1,4-butanediol dithioglycolate, ethylene glycol bismercaptopropionate, ethylene glycol bisthioglycolate, 1,4-butanediol bismercaptopropionate, trimethylolpropane tristhioglycolate, trimethylolpropane trismercaptopropionate, pentaerythritol tetrakisthioglycolate, pentaerythritol tetrakismercaptopropionate, dipentaerythritol hexamercaptopropionate, other esters of a polyhydric alcohol and mercaptopropionic acid, tris(2-hydroxyethyl)trimercaptopropionate isocyanurate, 1,4-dimethylmercaptobenzene, 2,4,6-trimercapto-s-triazine, 2-(N,N-dibutylamino)-4,6-dimercapto-s-triazine, 1,4-bis(3-mercaptobutyryloxy)butane, and pentaerythritol tetrakis(3-mercaptobutyrate).

Among them, it is preferable to use at least one compound selected from the group consisting of trimethylolpropane tris(3-mercaptopropionate), 1,4-butanediol dithioglycolate, pentaerythritol tetrakis(3-mercaptopropionate), 1,6-hexanedithiol, tris(2-hydroxyethyl)tri(3-mercaptopropionate) isocyanurate, dipentaerythritol hexa(3-mercaptopropionate), and 4-methoxybutyl 3-mercaptopropionate, and it is more preferable to use at least one compound selected from the group consisting of trimethylolpropane tris(3-mercaptopropionate), 1,4-butanediol dithioglycolate, pentaerythritol tetrakis(3-mercaptopropionate), 1,6-hexanedithiol, tris(2-hydroxyethyl)tri(3-mercaptopropionate) isocyanurate, and dipentaerythritol hexa(3-mercaptopropionate).

The disulfide compound may be a compound having at least one disulfide bond (—S—S—), and preferred examples thereof include dibenzothiazyl disulfide, a cyclic disulfide formed from the above thiol compound, and disulfides that are dimers of the above monofunctional thiol compound.

The chain transfer agent may be used singly or in a combination of two or more types. It is preferable to use a polyfunctional thiol compound rather than a monofunctional thiol compound since the amount of monomer remaining in the radiation-cured layer after curing (hereinafter, called the amount of residual monomer) is less.

It is preferable for the chain transfer agent that can be used in the present invention not to have a polar group such as —SO₃M, —OSO₃M, —PO(OM)₂, —OPO(OM)₂, or —COOM (M denotes a hydrogen atom, an alkali metal, or ammonium).

The radiation-cured layer of the magnetic recording medium of the present invention contains a residue of the chain transfer agent in a structure obtained by curing the radiation curing monomer, and it is preferable for it to contain a sulfide group (—S—).

When a radiation curing monomer is polymerized in the presence of the chain transfer agent under an atmosphere having a certain oxygen concentration, the amount of residual monomer can be reduced compared with the conventional level. Furthermore, even when the oxygen concentration is as high as that in the atmosphere, the amount of residual monomer can be reduced compared with the conventional level.

### 3. Amount of Chain Transfer Agent Used

The amount of chain transfer agent used in the radiation-cured layer is preferably 1 to 80 parts by weight relative to 100 parts by weight of the solids content of the radiation-cured layer, more preferably 2 to 50 parts by weight, yet more preferably 3 to 40 parts by weight, and most preferably 5 to 30 parts by weight. When the amount is in the above-mentioned range, since the amount of residual monomer can be reduced, sticking does not occur, and a magnetic recording medium having excellent curability and durability can be obtained. When substantially free of radiation curing monomer, a curing reaction does not proceed.

Moreover, it is preferable for the radiation-cured layer not to contain any binder, and it is more preferable for it to be a layer obtained by curing by radiation a layer substantially comprising a chain transfer agent and a radiation curing monomer.

### 4. Exposure to Radiation

Examples of the radiation used in the present invention include various types of radiation such as an electron beam (β rays), ultraviolet rays, X rays, γ rays, and α rays.

When ultraviolet rays are used, it is necessary to add a photopolymerization initiator to the above-mentioned compound. In the case of curing with an electron beam, no polymerization initiator is required, and the electron beam has a deep penetration depth, which is preferable.

With regard to electron beam accelerators that can be used here, there are a scanning system, a double scanning system, and a curtain beam system, and the curtain beam system is preferable since it is relatively inexpensive and gives a high output. With regard to electron beam characteristics, the acceleration voltage is 30 to 1,000 kV, and preferably 50 to 300 kV. The absorbed dose is 5 to 200 kGy, and preferably 10 to 100 kGy. When the acceleration voltage is in the above-mentioned range, the amount of energy penetrating is sufficient, and the efficiency of energy usage in polymerization is high, which is economical.

With regard to the atmosphere under which irradiation with an electron beam is carried out, it is generally said that, in order to prevent any inhibition of a curing reaction in the vicinity of the surface, the oxygen concentration is preferably adjusted by means of a nitrogen purge so as to be 200 ppm or less, but in the present invention since curing is possible at a high oxygen concentration, the oxygen concentration is not particularly limited. Needless to say, however, equipment and economics permitting, a low oxygen concentration is more preferable since the curability of the radiation-cured layer is superior. The oxygen concentration is preferably no greater than 12 vol %, more preferably no greater than 10 vol %, and yet more preferably no greater than 5 vol %.

As a light source for the ultraviolet rays, a mercury lamp is used. The mercury lamp is a 20 to 240 W/cm² lamp and is used at a speed of 0.3 to 20 m/min. The distance between a substrate and the mercury lamp is generally preferably 1 to 30 cm.

As the photopolymerization initiator used for ultraviolet curing, a radical photopolymerization initiator is used. More particularly, those described in, for example, ‘Shinkobunshi Jikkenngaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone.

The mixing ratio of the photopolymerization initiator is preferably 0.5 to 20 parts by weight relative to 100 parts by weight of the radiation curing compound, more preferably 2 to 15 parts by weight, and yet more preferably 3 to 10 parts by weight.

With regard to the radiation-curing equipment, conditions, etc., known equipment and conditions described in ‘UV•EB Kokagijutsu’ (UV/EB Radiation Curing Technology) (published by the Sogo Gijutsu Center), ‘Teienerugi Denshisenshosha no Oyogijutsu’ (Application of Low-energy Electron Beam) (2000, Published by CMC), etc. can be employed.

### 5. Thickness of Radiation-Cured Layer

With regard to the constitution of the magnetic recording medium used in the present invention, the radiation-cured layer preferably has a thickness of 0.1 to 1.5 μm, more preferably 0.2 to 1.4 μm, and yet more preferably 0.2 to 1.0 μm. When the thickness is in the above-mentioned range, a magnetic recording medium having excellent smoothness and good adhesion to a non-magnetic support can be obtained.

### II. Magnetic Layer

The magnetic recording medium of the present invention comprises, above a non-magnetic support, a magnetic layer having a ferromagnetic powder dispersed in a binder.

### 1. Ferromagnetic Powder

It is preferable for the magnetic recording medium of the present invention to employ as a ferromagnetic powder an acicular ferromagnetic substance, a tabular magnetic substance, or a spherical or ellipsoidal magnetic substance. Each thereof is explained below.

### (1) Acicular Magnetic Substance

The ferromagnetic metal powder used in the magnetic recording medium of the present invention is preferably an acicular cobalt-containing ferromagnetic iron oxide or ferromagnetic alloy powder. The specific surface area measured by the BET method (S_{BET}) is preferably 40 to 80 m²/g, and more preferably 50 to 70 m²/g. The crystallite size is preferably 12 to 25 nm, more preferably 13 to 22 nm, and particularly preferably 14 to 20 nm. The length of the major axis is preferably 20 to 50 nm, and more preferably 20 to 45 nm.

Examples of the ferromagnetic metal powder include yttrium-containing Fe, Fe—Co, Fe—Ni, and Co—Ni—Fe, and the yttrium content in the ferromagnetic metal powder is preferably 0.5 to 20 atom % as the yttrium atom/iron atom ratio Y/Fe, and more preferably 5 to 10 atom %.

It is preferable if the yttrium content is in such a range since the ferromagnetic metal powder has a high as value, and good magnetic properties and electromagnetic conversion characteristics can be obtained. Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

One example of a process for producing the ferromagnetic metal powder of the present invention, into which cobalt or yttrium has been introduced, is illustrated below. For example, an iron oxyhydroxide obtained by blowing an oxidizing gas into an aqueous suspension in which a ferrous salt and an alkali have been mixed can be used as a starting material.

This iron oxyhydroxide is preferably of the α-FeOOH type. With regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain an Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable.

In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

In the present invention, neodymium, samarium, praseodymium, lanthanum, gadolinium, etc. can be introduced into the ferromagnetic metal powder of the present invention as well as yttrium. They can be introduced using a chloride such as yttrium chloride, neodymium chloride, samarium chloride, praseodymium chloride, or lanthanum chloride or a nitrate salt such as neodymium nitrate or gadolinium nitrate, and they can be used in a combination of two or more types.

The coercive force (Hc) of the ferromagnetic metal powder is preferably 159.2 to 238.8 kA/m (2.000 to 3,000 Oe), and more preferably 167.2 to 230.8 kA/m (2,100 to 2,900 Oe). The saturation magnetic flux density is preferably 150 to 300 mT (1,500 to 3,000 G), and more preferably 160 to 290 mT (1,600 to 2,900 G). The saturation magnetization (as) is preferably 100 to 170 A·m²/kg (100 to 170 emu/g), and more preferably 100 to 160 A·m²/kg (100 tp 160 emu/g). The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle distribution of goethite, a technique of using monodispersed α-Fe₂O₃, and a technique of preventing sintering between particles, etc. in the ferromagnetic metal powder.

### (2) Tabular Magnetic Substance

The tabular magnetic substance that can be used in the present invention is preferably a hexagonal ferrite powder.

Examples of the hexagonal ferrite powder include substitution products of barium ferrite, strontium ferrite, lead ferrite, and calcium ferrite, and Co substitution products. Specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. It may contain, in addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr. In general, those to which Co—Zn, Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is preferably 10 to 50 nm as a hexagonal plate size. When a magnetoresistive head is used for playback, the plate size is preferably equal to or less than 45 nm so as to reduce noise. It is preferable if the plate size is in such a range, since stable magnetization can be expected due to the absence of thermal fluctuations. And since noise is reduced it is suitable for high density magnetic recording.

The tabular ratio (plate size/plate thickness) is preferably 1 to 15, and more preferably 2 to 7. It is preferable if the tabular ratio is in such a range since adequate orientation can be obtained, and noise due to inter-particle stacking decreases. The S_{BET} of a powder having a particle size within this range is usually 10 to 200 m²/g. The specific surface area substantially coincides with the value obtained by calculation using the plate size and the plate thickness. The crystallite size is preferably 50 to 450 nm, and more preferably 100 to 350 nm. The plate size and the plate thickness distributions are preferably as narrow as possible. Although it is difficult, the distribution can be expressed using a numerical value by randomly measuring 500 particles on a TEM photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the magnetic substance can be adjusted so as to be on the order of 39.8 to 398 kA/m (500 to 5,000 Oe). A higher Hc is advantageous for high-density recording, but it is restricted by the capacity of the recording head. It is preferably on the order of 63.7 to 318.4 kA/m (800 to 4,000 Oe), but is more preferably at least 119.4 kA/m (1,500 Oe) and at most 278.6 kA/m (3,500 Oe). When the saturation magnetization of the head exceeds 1.4 T, it is preferably 159.2 kA/m (2,000 Oe) or higher.

The Hc can be controlled by the particle size (plate size, plate thickness), the type and amount of element included, the element replacement sites, the conditions used for the particle formation reaction, etc. The saturation magnetization (as) is preferably 40 to 80 A·m²/kg (40 to 80 emu/g). A higher as is preferable, but there is a tendency for it to become lower when the particles become finer. In order to improve the as, making a composite of magnetoplumbite ferrite with spinel ferrite, selecting the types of element included and their amount, etc. are well known. It is also possible to use a W type hexagonal ferrite.

When dispersing the magnetic substance, the surface of the magnetic substance can be treated with a material that is compatible with a dispersing medium and the polymer. With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance. The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the magnetic recording medium. The moisture contained in the magnetic substance also influences the dispersion. Although the optimum value depends on the dispersing medium and the polymer, it is usually selected from 0.01% to 2.0%.

With regard to a production method for the ferromagnetic hexagonal ferrite powder, there are:

glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder;

hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; and

co-precipitation method (3) in which a barium ferrite composition metal salt solution is neutralized with an alkali, and after a by-product is removed, it is dried and treated at 1100° C. or less, and ground to give a barium ferrite crystal powder, etc., but a hexagonal ferrite used in the present invention may be produced by any method.

### (3) Spherical or Ellipsoidal Magnetic Substance

The spherical or ellipsoidal magnetic substance is preferably an iron nitride-based ferromagnetic powder containing Fe₁₆N₂ as a main phase. It may comprise, in addition to Fe and N atoms, an atom such as Al, Si, S, Sc, Ti, V, Cr, Cu, Y, Mo, Rhh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, or Nb. The content of N relative to Fe is preferably 1.0 to 20.0 atom %.

The iron nitride is preferably spherical or ellipsoidal, and the major axis length/minor axis length axial ratio is preferably 1 to 2. The BET specific surface area (S_{BET}) is preferably 30 to 100 m²/g, and more preferably 50 to 70 m²/g. The crystallite size is preferably 12 to 25 nm, and more preferably 13 to 22 nm. The saturation magnetization as is preferably 50 to 200 A·m²/kg (emu/g), and more preferably 70 to 150 A·m²/kg (emu/g).

### 2. Binder

Examples of the binder used in the magnetic layer include a polyurethane resin, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl alkyral resin such as polyvinyl acetal or polyvinyl butyral, and they can be used singly or in a combination of two or more types. Among these, the polyurethane resin, the acrylic resin, the cellulose resin, and the vinyl chloride resin are preferable.

In order to improve the dispersibility of the ferromagnetic powder and the non-magnetic powder, the binder preferably has a functional group (polar group) that is adsorbed on the surface of the powders. Preferred examples of the functional group include —SO₃M, —SO₄M, —PO(OM)₂, —OPO(OM)₂, —COOM, >NSO₃M, >NRSO₃M, —NR¹R², and —N⁺R¹R²R³X⁻. M denotes a hydrogen atom or an alkali metal such as Na or K, R denotes an alkylene group, R¹, R², and R³ denote alkyl groups, hydroxyalkyl groups, or hydrogen atoms, and X denotes a halogen such as Cl or Br. The amount of functional group in the binder is preferably 10 to 200 μeq/g, and more preferably 30 to 120 μeq/g. It is preferable if it is in this range since good dispersibility can be achieved.

The binder preferably includes, in addition to the adsorbing functional group, a functional group having an active hydrogen, such as an —OH group, in order to improve the coating strength by reacting with an isocyanate curing agent so as to form a crosslinked structure. A preferred amount is 0.1 to 2 meq/g.

The molecular weight of the binder is preferably 10,000 to 200,000 as a weight-average molecular weight, and more preferably 20,000 to 100,000. It is preferable if the weight-average molecular weight is in this range since the coating strength is sufficient, the durability is good, and the dispersibility improves.

The polyurethane resin, which is a preferred binder, is described in detail in, for example, ‘Poriuretan Jushi Handobukku’ (Polyurethane Resin Handbook) (Ed., K. Iwata, 1986, The Nikkan Kogyo Shimbun, Ltd.), and it may normally be obtained by addition-polymerization of a long chain diol, a short chain diol (also known as a chain extending agent), and a diisocyanate compound. As the long chain diol, a polyester diol, a polyether diol, a polyetherester diol, a polycarbonate diol, a polyolefin diol, etc, having a molecular weight of 500 to 5,000 may be used. Depending on the type of this long chain polyol, the polyurethane is called a polyester urethane, a polyether urethane, a polyetherester urethane, a polycarbonate urethane, etc.

The polyester diol may be obtained by a condensation-polymerization between a glycol and a dibasic aliphatic acid such as adipic acid, sebacic acid, or azelaic acid, or a dibasic aromatic acid such as isophthalic acid, orthophthalic acid, terephthalic acid, or naphthalenedicarboxylic acid. Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol, 1,8-octanediol, 1,9-nonanediol, cyclohexanediol, cyclohexanedimethanol, and hydrogenated bisphenol A. As the polyester diol, in addition to the above, a polycaprolactonediol or a polyvalerolactonediol obtained by ring-opening polymerization of a lactone such as ε-caprolactone or γ-valerolactone can be used.

From the viewpoint of resistance to hydrolysis, the polyester diol is preferably one having a branched side chain or one obtained from an aromatic or alicyclic starting material. Examples of the polyether diol include polyethylene glycol, polypropylene glycol, polytetramethylene glycol, aromatic glycols such as bisphenol A, bisphenol S, bisphenol P, and hydrogenated bisphenol A, and addition-polymerization products from an alicyclic diol and an alkylene oxide such as ethylene oxide or propylene oxide. These long chain diols can be used as a mixture of a plurality of types thereof.

The short chain diol can be chosen from the compound group that is cited as the glycol component of the above-mentioned polyester diol. Furthermore, a small amount of a tri- or higher-hydric alcohol such as, for example, trimethylolethane, trimethylolpropane, or pentaerythritol can be added, and this gives a polyurethane resin having a branched structure, thus reducing the solution viscosity and increasing the number of OH end groups of the polyurethane so as to improve the curability with the isocyanate curing agent.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/diisocyanate ratio in the polyurethane resin is preferably (80 to 15 wt %)/(5 to 40 wt %)/(15 to 50 wt %).

The concentration of urethane groups in the polyurethane resin is preferably 1 to 5 meq/g, and more preferably 1.5 to 4.5 meq/g. It is preferable if the concentration of urethane groups is in the above range since the mechanical strength is high, the solution viscosity is low and the good dispersibility can be achieved.

The glass transition temperature of the polyurethane resin is preferably 0° C. to 200° C., and more preferably 40° C. to 160° C. In this range, sufficient durability and moldability are obtained, and excellent electromagnetic conversion characteristics are obtained.

With regard to a method for introducing the adsorbing functional group (polar group) into the polyurethane resin, there are, for example, a method in which the functional group is used in a part of the long chain diol monomer, a method in which it is used in a part of the short chain diol, and a method in which, after the polyurethane is formed by polymerization, the polar group is introduced by a polymer reaction.

As the vinyl chloride resin, a copolymer of a vinyl chloride monomer and various types of monomer may be used.

Examples of the comonomer include fatty acid vinyl esters such as vinyl acetate and vinyl propionate, acrylates and methacrylates such as methyl (meth)acrylate, ethyl (meth)acrylate, isopropyl (meth)acrylate, butyl (meth)acrylate, and benzyl (meth)acrylate, alkyl allyl ethers such as allyl methyl ether, allyl ethyl ether, allyl propyl ether, and allyl butyl ether, and others such as styrene, α-methylstyrene, vinylidene chloride, acrylonitrile, ethylene, butadiene, and acrylamide; examples of a comonomer having a functional group include vinyl alcohol, 2-hydroxyethyl (meth)acrylate, polyethylene glycol (meth)acrylate, 2-hydroxypropyl (meth)acrylate, 3-hydroxypropyl (meth)acrylate, polypropylene glycol (meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glycidyl (meth)acrylate, allyl glycidyl ether, phosphoethyl (meth)acrylate, sulfoethyl (meth)acrylate, p-styrenesulfonic acid, and Na salts and K salts thereof.

The proportion of the vinyl chloride monomer in the vinyl chloride resin is preferably 60 to 95 wt %. It is preferable if it is in this range since the mechanical strength improves, the solvent solubility is high, and good dispersibility can be obtained due to desirable solution viscosity.

A preferred amount of a functional group for improving the curability of the adsorbing functional group (polar group) with a polyisocyanate curing agent is as described above. With regard to a method for introducing these functional groups, a monomer containing the above-mentioned functional group may be copolymerized, or after the vinyl chloride resin is formed by copolymerization, the functional group may be introduced by a polymer reaction.

A preferred degree of polymerization is 200 to 600, and more preferably 240 to 450. It is preferable if the degree of polymerization is in this range since the mechanical strength is high and good dispersibility can be obtained due to desirable solution viscosity.

In order to increase the mechanical strength and heat resistance of a coating by crosslinking and curing the binder used in the present invention, it is possible to use a curing agent. A preferred curing agent is a polyisocyanate compound. The polyisocyanate compound is preferably a tri- or higher-functional polyisocyanate.

Specific examples thereof include adduct type polyisocyanate compounds such as a compound in which 3 moles of TDI (tolylene diisocyanate) are added to 1 mole of trimethylolpropane (TMP), a compound in which 3 moles of HDI (hexamethylene diisocyanate) are added to 1 mole of TMP, a compound in which 3 moles of IPDI (isophorone diisocyanate) are added to 1 mole of TMP, and a compound in which 3 moles of XDI (xylylene diisocyanate) are added to 1 mole of TMP, a condensed isocyanurate type trimer of TDI, a condensed isocyanurate type pentamer of TDI, a condensed isocyanurate heptamer of TDI, mixtures thereof, an isocyanurate type condensation product of HDI, an isocyanurate type condensation product of IPDI, and crude MDI.

Among these, the compound in which 3 moles of TDI are added to 1 mole of TMP, and the isocyanurate type trimer of TDI are preferable.

Other than the isocyanate curing agents, a radiation curing agent that cures when exposed to an electron beam, ultraviolet rays, etc. may be used. In this case, it is possible to use a curing agent having, as radiation curing functional groups, two or more, and preferably three or more, acryloyl or methacryloyl groups per molecule. Examples thereof include TMP (trimethylolpropane) triacrylate, pentaerythritol tetraacrylate, and a urethane acrylate oligomer. In this case, it is preferable to introduce a (meth)acryloyl group not only into the curing agent but also into the binder. In the case of curing with ultraviolet rays, a photosensitizer is additionally used.

It is preferable to add 0 to 80 parts by weight of the curing agent relative to 100 parts by weight of the binder. It is preferable if the amount is in this range since the dispersibility is good.

The amount of binder added to the magnetic layer is preferably 5 to 30 parts by weight relative to 100 parts by weight of the ferromagnetic powder, and more preferably 10 to 20 parts by weight.

### 3. Additives

Additives may be added as necessary to the magnetic layer of the present invention. Examples of the additives include an abrasive, a lubricant, a dispersant/dispersion adjuvant, a fungicide, an antistatic agent, an antioxidant, a solvent, and carbon black.

Examples of these additives include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; and alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, linolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing).

These dispersants, lubricants, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd); Enujelv OL (produced by New Japan Chemical Co., Ltd.); TA-3 (produced by Shin-Etsu Chemical Industry Co., Ltd.); Amide P (produced by Lion Armour); Duomin TDO (produced by Lion Corporation); BA-41G (produced by The Nisshin Oilli 0 Group, Ltd.); and Profan 2012E, Newpol PE 61, and lonet MS-400 (produced by Sanyo Chemical Industries, Ltd.).

### 4. Organic Solvent

In the present invention, an organic solvent used for the magnetic layer can be a known organic solvent. As the organic solvent, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, or cresol, a chlorohydrocarbon such as methylene chloride, ethylene chloride, carbon tetrachloride, chloroform, ethylene chlorohydrin, chlorobenzene, or dichlorobenzene, N,N-dimethylformamide, hexane, tetrahydrofuran, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and a non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer (upper layer) solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

The type and the amount of the dispersant, lubricant, and surfactant used in the magnetic layer of the present invention can be changed as necessary in the magnetic layer and a non-magnetic layer, which will be described later. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, which will be described later, and once adsorbed it is hard to desorb an organophosphorus compound from the surface of a metal, a metal compound, etc. Therefore, since in the present invention the surface of the ferromagnetic powder or the surface of a non-magnetic powder, which will be described later, are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer. Furthermore, all or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

### 5. Carbon Black

In the present invention, the magnetic layer may comprise carbon black as necessary.

Adding carbon black enables the surface electrical resistance Rs to be reduced, which is a known effect, the light transmittance to be reduced, and a desired micro Vickers hardness to be obtained.

The type of carbon black that can be used includes furnace black for rubber, thermal black for rubber, carbon black for coloring, acetylene black, etc.

The carbon black may be used singly or in a combination of different types thereof. When the carbon black is used, it is preferably used in an amount of 0.1 to 30 wt % based on the weight of the ferromagnetic powder. The carbon black has the functions of preventing static charging of the magnetic layer, reducing the coefficient of friction, imparting light-shielding properties, and improving the film strength. Such functions vary depending upon the type of carbon black. Accordingly, it is of course possible in the present invention to appropriately choose the type, the amount and the combination of carbon black for the magnetic layer according to the intended purpose on the basis of the above mentioned various properties such as the particle size, the oil absorption, the electrical conductivity, and the pH value, and it is better if they are optimized for the respective layers.

The specific surface area of the carbon black is preferably 100 to 500 m²/g, and more preferably 150 to 400 m²/g. The dibutylphthalate (DBP) oil absorption thereof is preferably 20 to 400 mL/100 g, and more preferably 30 to 200 mL/100 g. The average particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, MA-600, MA-230, #4000, and #4010 (manufactured by Mitsubishi Chemical Corporation), CONDUCTEX SC, RAVEN 8800, 8000, 7000, 5750, 5250, 3500, 2100, 2000, 1800, 1500, 1255, and 1250 (manufactured by Columbian Carbon Co.), Ketjen Black EC (manufactured by Akzo), Ketjen Black EC (manufactured by Ketjen Black International Co.).

The carbon black that can be used in the present invention can be selected by referring to, for example, the ‘Kabon Burakku Binran’ (Carbon Black Handbook) (edited by the Carbon Black Association of Japan).

### III. Non-Magnetic Layer

The magnetic recording medium of the present invention can include a non-magnetic layer on a non-magnetic support, the non-magnetic layer containing a binder and a non-magnetic powder. The non-magnetic powder that can be used in the non-magnetic layer may be an inorganic substance or an organic substance.

The non-magnetic layer may further include carbon black as necessary together with the non-magnetic powder.

### Non-Magnetic Powder

Details of the non-magnetic layer are now explained.

The magnetic recording medium of the present invention may include a non-magnetic layer including a non-magnetic powder and a binder above a non-magnetic support provided with a radiation-cured layer.

The non-magnetic layer may employ a magnetic powder as long as the lower layer is substantially non-magnetic, but preferably employs a non-magnetic powder.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide.

Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-iron oxide or a titanium oxide is preferable.

The form of the non-magnetic powder may be any one of acicular, spherical, polyhedral, and tabular.

The crystallite size of the non-magnetic powder is preferably 4 nm to 1 μm, and more preferably 40 to 100 nm. When the crystallite size is in the range of 4 nm to 1 μm, there are no problems with dispersion and a suitable surface roughness is obtained.

The average particle size of these non-magnetic powders is preferably 5 nm to 2 μm, but it is possible to combine non-magnetic powders having different average particle sizes as necessary, or widen the particle size distribution of a single non-magnetic powder, thus producing the same effect. The average particle size of the non-magnetic powder is particularly preferably 10 to 200 nm. It is preferable if it is in the range of 5 nm to 2 μm, since good dispersibility and a suitable surface roughness can be obtained.

The specific surface area of the non-magnetic powder is preferably 1 to 100 m²/g, more preferably 5 to 70 m²/g, and yet more preferably 10 to 65 m²/g. It is preferable if the specific surface area is in the range of 1 to 100 m²/g, since a suitable surface roughness can be obtained, and dispersion can be carried out using a desired amount of binder.

The oil absorption obtained using dibutyl phthalate (DBP) is preferably 5 to 100 mL/100 g, more preferably 10 to 80 mL/100 g, and yet more preferably 20 to 60 mL/100 g.

The specific gravity is preferably 1 to 12, and more preferably 3 to 6. The tap density is preferably 0.05 to 2 g/mL, and more preferably 0.2 to 1.5 g/mL. When the tap density is in the range of 0.05 to 2 g/mL, there is little scattering of particles, the operation is easy, and there tends to be little sticking to equipment.

The pH of the non-magnetic powder is preferably 2 to 11, and particularly preferably 6 to 9. When the pH is in the range of 2 to 11, the coefficient of friction does not increase as a result of high temperature and high humidity or release of a fatty acid.

The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. When the Mohs hardness is in the range of 4 to 10, it is possible to guarantee the durability. The amount of stearic acid absorbed by the non-magnetic powder is 1 to 20 μmol/m², and preferably 2 to 15 μmol/m².

The heat of wetting of the non-magnetic powder in water at 25° C. is preferably in the range of 20 to 60 μJ/cm² (200 to 600 erg/cm²). It is possible to use a solvent that gives a heat of wetting in this range.

The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly.

Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer in the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, and SN-100, MJ-7, and α-iron oxide E270, E271, and E300 (manufactured by Ishihara Sangyo Kaisha Ltd.), titanium oxide STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO₂P25 (manufactured by Nippon Aerosil Co., Ltd.), 100A, and 500A (manufactured by Ube Industries, Ltd.), Y-LOP (manufactured by Titan Kogyo Kabushiki Kaisha), and calcined products thereof. Particularly preferred non-magnetic powders are titanium dioxide and α-iron oxide.

By mixing carbon black with the non-magnetic powder, the surface electrical resistance of the non-magnetic layer can be reduced, the light transmittance can be decreased, and a desired μVickers hardness can be obtained. The μVickers hardness of the non-magnetic layer is preferably 25 to 60 kg/mm², and is more preferably 30 to 50 kg/mm² in order to adjust the head contact. The μVickers hardness can be measured using a thin film hardness meter (HMA-400 manufactured by NEC Corporation) with, as an indenter tip, a triangular pyramidal diamond needle having a tip angle of 80° and a tip radius of 0.1 μm. The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer in the present invention is preferably 100 to 500 m²/g, and more preferably 150 to 400 m²/g, and the DBP oil absorption thereof is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black that can be used in the non-magnetic layer in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), Ketjen Black EC (manufactured by Akzo), and Ketjen Black EC (manufactured by Ketjen Black International Corporation).

The carbon black may be surface treated using a dispersant or grafted with a resin, or part of the surface thereof may be converted into graphite. Prior to adding carbon black to a coating solution, the carbon black may be predispersed with a binder. The carbon black is preferably used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Binran (Carbon Black Handbook) (edited by the Carbon Black Association of Japan).

It is also possible to add an organic powder to the non-magnetic layer, depending on the intended purpose. Examples of such an organic powder include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used. Production methods such as those described in JP-A-62-18564 and JP-A-60-255827 may be used.

### IV. Non-Magnetic Support

With regard to the non-magnetic support that can be used in the present invention, known biaxially stretched films such as polyethylene terephthalate, polyethylene naphthalate, polyamide, polyamideimide, and aromatic polyamide can be used. Among these, polyethylene terephthalate, polyethylene naphthalate, and polyamide are preferred.

These supports may be subjected in advance to a corona discharge treatment, a plasma treatment, a treatment for enhancing adhesion, a thermal treatment, etc. The non-magnetic support that can be used in the present invention preferably has a surface roughness such that its center plane average surface roughness Ra is in the range of 3 to 10 nm for a cutoff value of 0.25 mm.

### V. Backcoat Layer

In general, there is a strong requirement for magnetic tapes for recording computer data to have better repetitive transport properties than video tapes and audio tapes. In order to maintain such high storage stability, a backcoat layer can be provided on the surface of the non-magnetic support opposite to the surface where the non-magnetic layer and the magnetic layer are provided. As a coating solution for the backcoat layer, a binder and a particulate component such as an abrasive or an antistatic agent are dispersed in an organic solvent. As a granular component, various types of inorganic pigment or carbon black may be used. As the binder, a resin such as nitrocellulose, a phenoxy resin, a vinyl chloride resin, or a polyurethane can be used singly or in combination.

### VI. Layer Structure

The thickness of the non-magnetic support is preferably 3 to 80 μm. Moreover, the thickness of the backcoat layer provided on the surface of the non-magnetic support opposite to the surface where the non-magnetic layer and the magnetic layer are provided is preferably 0.1 to 1.0 μm, and more preferably 0.2 to 0.8 μm.

The thickness of the magnetic layer is optimized according to the saturation magnetization and the head gap of the magnetic head and the bandwidth of the recording signal, but it is preferably 0.01 to 0.12 μm, and more preferably 0.02 to 0.10 μm. The percentage variation in thickness of the magnetic layer is preferably ±50% or less, and more preferably ±40% or less. The magnetic layer can be at least one layer, but it is also possible to provide two or more separate layers having different magnetic properties, and a known configuration for a multilayer magnetic layer can be employed.

In the present invention, the presence or absence of a non-magnetic layer is optional. In the case of a constitution having a non-magnetic layer, the non-magnetic layer preferably has a thickness of 0.2 to 3.0 μm, more preferably 0.3 to 2.5 μm, and yet more preferably 0.4 to 2.0 μm.

The non-magnetic layer of the magnetic recording medium of the present invention exhibits its effect if it is substantially non-magnetic, but even if it contains a small amount of a magnetic substance as an impurity or intentionally, if the effects of the present invention are exhibited the constitution can be considered to be substantially the same as that of the magnetic recording medium of the present invention. ‘Substantially the same’ referred to here means that the non-magnetic layer has a residual magnetic flux density of 10 mT (100 G) or less or a coercive force of 7.96 kA/m (100 Oe) or less, and preferably has no residual magnetic flux density and no coercive force.

### VII. Production Method

A process for producing a non magnetic layer coating solution or a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages. All materials, including the ferromagnetic hexagonal ferrite powder, the ferromagnetic metal powder, the non-magnetic powder, the binder, the carbon black, the abrasive, the antistatic agent, the lubricant, and the solvent used in the present invention may be added in any step from the beginning or during the course of the step. The addition of each material may be divided across two or more steps. For example, a polyurethane can be divided and added in a kneading step, a dispersing step, and a blending step for adjusting the viscosity after dispersion.

A method for preparing the radiation-cured layer is not particularly limited, and a known method may be employed. There can be cited, for example, a process in which a non-magnetic support is coated with a liquid mixture in which a radiation curing monomer and a chain transfer agent are dissolved in a solvent such as an organic solvent or water, dried, and then exposed to radiation, thus curing a radiation-cured layer.

To attain the object of the present invention, a conventionally known production technique may be employed as a part of the steps. In the kneading step, it is preferable to use a powerful kneading machine such as an open kneader, a continuous kneader, a pressure kneader, or an extruder. When a kneader is used, all or a part of the binder (preferably 30 wt % or above of the entire binder) and the magnetic powder or the non-magnetic powder are kneaded at 15 to 500 parts by weight relative to 100 parts by weight of the ferromagnetic powder. Details of these kneading treatments are described in JP-A-1-106338 and JP-A-1-79274. For the dispersion of the magnetic layer solution and a non-magnetic layer solution, glass beads may be used. As such glass beads, a dispersing medium having a high specific gravity such as zirconia beads, titania beads, or steel beads is suitably used. An optimal particle size and packing density of these dispersing media is used. A known disperser can be used.

The process for producing the magnetic recording medium of the present invention includes, for example, coating the surface of a moving non-magnetic support with a magnetic layer coating solution so as to give a predetermined coating thickness. A plurality of magnetic layer coating solutions can be applied successively or simultaneously in multilayer coating, and a lower non-magnetic layer coating solution and an upper magnetic layer coating solution can also be applied successively or simultaneously in multilayer coating. As coating equipment for applying the above-mentioned magnetic layer coating solution or the lower non-magnetic layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a fine ferromagnetic metal powder, in general, in-plane two-dimensional random is preferable, but it can be three-dimensional random by introducing a vertical component. In the case of a hexagonal ferrite, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 to 1,000 m/min and the temperature of drying air to be 60° C. or higher, and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to carry out a treatment with metal rolls. The magnetic recording medium of the present invention preferably has a surface, which is extremely smooth. As a method therefor, a magnetic layer formed by selecting a specific ferromagnetic powder and binder as described above is subjected to the above-mentioned calendering treatment. With regard to calendering conditions, the calender roll temperature is preferably in the range of 60° C. to 100° C., more preferably in the range of 70° C. to 100° C., and particularly preferably in the range of 80° C. to 100° C., and the pressure is preferably in the range of 100 to 500 kg/cm, more preferably in the range of 200 to 450 kg/cm, and particularly preferably in the range of 300 to 400 kg/cm.

As thermal shrinkage reducing means, there is a method in which a web is thermally treated while handling it with low tension, and a method (thermal treatment) involving thermal treatment of a tape when it is in a layered configuration such as in bulk or installed in a cassette, and either can be used. In the former method, the effect of the imprint of projections of the surface of the backcoat layer is small, but the thermal shrinkage cannot be greatly reduced. On the other hand, the latter thermal treatment can improve the thermal shrinkage greatly, but when the effect of the imprint of projections of the surface of the backcoat layer is strong, the surface of the magnetic layer is roughened, and this causes the output to decrease and the noise to increase. In particular, a high output and low noise magnetic recording medium can be provided for the magnetic recording medium accompanying the thermal treatment. The magnetic recording medium thus obtained can be cut to a desired size using a cutter, a stamper, etc. before use.

### VIII. Physical Properties, etc.

### 1. Radiation-Cured Layer

### (1) Amount of Residual Monomer

A polyethylene naphthalate support was coated with a liquid mixture for a radiation-cured layer, dried, and then exposed to radiation, thus giving a sample of the radiation-cured layer. Uncured monomer contained in the sample thus obtained was extracted into methyl ethyl ketone solvent at 40° C. for 2 hours. The monomer thus extracted was quantitatively analyzed using high performance liquid chromatography, and the amount of residual monomer was calculated relative to 100 parts by weight of the solids content of the radiation-cured layer. The amount of residual monomer is preferably less than 8 wt %, more preferably less than 6 wt %, and yet more preferably less than 4 wt %. When the amount is in the above-mentioned range, a magnetic recording medium having a low coefficient of friction and excellent durability can be obtained. The residual monomer is either of the thiol compound or the radiation curing monomer used, or a mixture thereof.

### (2) Average Roughness

The average roughness (Ra) of the radiation-cured layer is preferably 1 to 3 nm for a cutoff value of 0.25 nm. It is preferable if it is in this range since there are few problems with sticking to a path roller during a coating step and the magnetic layer has sufficient smoothness.

### (3) Glass Transition Temperature

In the present invention, the glass transition temperature (Tg) of the radiation-cured layer after curing is preferably 80° C. to 150° C., and more preferably 100° C. to 130° C. It is preferable if the glass transition temperature of the radiation-cured layer is in this range since there are no problems with tackiness during a coating step and the coating strength is desirable.

### (4) Modulus of Elasticity

In the present invention, the modulus of elasticity of the radiation-cured layer is preferably 1.5 to 10 GPa, and more preferably 2 to 10 GPa. When the modulus of elasticity is in the above-mentioned range, a radiation-cured layer having excellent coating strength and no problems due to tackiness is obtained.

### 2. Magnetic Layer/Non-Magnetic Layer

### (1) Residual Elongation and Thermal Shrinkage

The residual elongation of the magnetic layer and the non-magnetic layer is preferably at most 0.5%. The thermal shrinkage at any temperature not exceeding 100° C. is preferably at most 1%, more preferably at most 0.5%, and yet more preferably at most 0.1%.

### (2) Glass Transition Temperature, Loss Modulus and Loss Tangent

The glass transition temperature of the magnetic layer (the maximum point of the loss modulus in a dynamic viscoelasticity measurement at 110 Hz) is preferably 50° C. to 180° C., and that of the non-magnetic layer is preferably 0° C. to 180° C. The loss modulus is preferably in the range of 1×10⁷ to 8×10⁸ Pa (1×10⁸ to 8×10⁹ dyne/cm²), and the loss tangent is preferably 0.2 or less. It is preferable if the loss tangent is 0.2 or less, since the problem of tackiness hardly occurs. These thermal properties and mechanical properties are preferably substantially identical to within 10% in each direction in the plane of the medium.

### (3) Modulus of Elasticity, Breaking Strength

The modulus of elasticity of the magnetic layer at an elongation of 0.5% is preferably 0.98 to 19.6 GPa (100 to 2,000 kg/mm²) in each direction within the plane, and the breaking strength is preferably 98 to 686 MPa (10 to 70 kg/mm²).

### (4) Surface Roughness of Magnetic Layer, etc.

The center plane surface roughness R^{a} of the magnetic layer is preferably 4.0 nm or less, more preferably 3.0 nm or less, and yet more preferably 2.0 nm or less, when measured using a TOPO-3D (manufactured by WAKO corporation). The maximum height SRₘₐₓ of the magnetic layer is preferably 0.5 μm or less, the ten-point average roughness SRz is 0.3 μm or less, the center plane peak height SRp is 0.3 μm or less, the center plane valley depth SRv is 0.3 μm or less, the center plane area factor SSr is 20% to 80%, and the average wavelength Sλa is 5 to 300 μm. It is possible to set the number of surface projections on the magnetic layer having a size of 0.01 to 1 μm at any level in the range of 0 to 2,000 projections per 100 μm², and by so doing the electromagnetic conversion characteristics and the coefficient of friction can be optimized, which is preferable.

They can be controlled easily by controlling the surface properties of the support by means of a filler, the particle size and the amount of a powder added to the magnetic layer, and the shape of the roll surface in the calendering process. The curl is preferably within ±3 mm.

### (5) Saturation Magnetic Flux Density

The saturation magnetic flux density of the magnetic layer of the magnetic recording medium used in the present invention is preferably 100 to 300 mT (1,000 to 3,000 G).

### (6) Coercive Force

The coercive force (Hc) of the magnetic layer is preferably 143.3 to 318.4 kA/m (1,800 to 4,000 Oe), and more preferably 159.2 to 278.6 kA/m (2,000 to 3,500 Oe). It is preferable for the coercive force distribution to be narrow, and the SFD and SFDr are preferably 0.6 or less, and more preferably 0.2 or less.

### (7) Electrostatic Potential

The electrostatic potential is preferably −500 V to +500 V.

### (8) Residual Solvent, Porosity

Residual solvent in the magnetic layer is preferably 100 mg/m² or less, and more preferably 10 mg/m² or less. The porosity of the coating layer is preferably 30 vol % or less for both the non-magnetic layer and the magnetic layer, and more preferably 20 vol % or less. In order to achieve a high output, the porosity is preferably small, but there are cases in which a certain value should be maintained depending on the intended purpose. For example, in the case of disk media where repetitive use is considered to be important, a large porosity is often preferable from the point of view of storage stability.

When the magnetic recording medium of the present invention has a non-magnetic layer and a magnetic layer, it can easily be anticipated that the physical properties of the non-magnetic layer and the magnetic layer can be varied according to the intended purpose. For example, the elastic modulus of the magnetic layer can be made high, thereby improving the storage stability, and at the same time the elastic modulus of the non-magnetic layer can be made lower than that of the magnetic layer, thereby improving the head contact of the magnetic recording medium.

### 3. Magnetic Recording Medium

### (1) Coefficient of Friction

Measurement of the coefficient of friction was carried out by sliding repeatedly for 10 passes at 14 mm/sec in an environment of 23° C. and 70% RH while the surface of the magnetic layer was made to contact an SUS420 member with a load of 50 g, and the coefficient of friction during the tenth pass was measured.

A preferred value for the coefficient of friction is no greater than 0.32, and more preferably no greater than 0.3. When the value is in the above-mentioned range, the transport durability is excellent.

### (2) Saturation Magnetization

A head used for playback of signals recorded magnetically on the magnetic recording medium of the present invention is not particularly limited, but an MR head is preferably used. When an MR head is used for playback of the magnetic recording medium of the present invention, the MR head is not particularly limited and, for example, a GMR head or a TMR head may be used. A head used for magnetic recording is not particularly limited, but it is preferable for the saturation magnetization to be 1.0 T or more, and more preferably 1.5 T or more.

### (3) Modulus of Elasticity

The modulus of elasticity of the magnetic recording medium is preferably 0.98 to 14.7 GPa (100 to 1,500 kg/mm²) in each direction within the plane.

In accordance with the present invention, it is possible to provide a magnetic recording medium having (1) excellent smoothness, (2) a low coefficient of friction, (3) excellent electromagnetic conversion characteristics and error characteristics, and (4) excellent transport durability and storage stability and, furthermore, a radiation-cured layer having (5) a low amount of residual monomer even when there is a high oxygen concentration.

### EXAMPLES

The present invention is explained more specifically below by reference to Examples, but the present invention should not be construed as being limited thereby. ‘Parts’ in the Examples means ‘parts by weight’ unless otherwise specified.

### Example 1

| | |
|---|---|
| 1,4-Butanediol diacrylate | 85 parts, |
| trimethylolpropane tris(3-mercaptopropionate) (T-1) | 15 parts, and |
| methyl ethyl ketone (hereinafter, called MEK) | 400 parts |

were mixed, stirred for 20 minutes, and filtered using a filter having an average pore size of 1 μm to give a liquid mixture for a radiation-cured layer.

### Preparation of Magnetic Layer Coating Solution

| | | |
|---|---|---|
| 100 parts of ferromagnetic alloy powder A (composition: Co 20%, Al 9%, | 30 | parts, and |
| and Y 6% relative to 100 atom % Fe; Hc 175 kA/m; crystallite size 11 nm; BET | | |
| specific surface area 70 m²/g; major axis length 45 nm; σs 111 emu/g) was ground | | |
| in an open kneader for 10 minutes, and then kneaded for 60 minutes with | | |
| a 30% cyclohexanone solution of a vinyl chloride-based copolymer (MR110, | | |
| manufactured by Nippon Zeon Corporation) | | |
| a 30% MEK/toluene = 1/1 solution of a polyurethane resin (UR8200, manufactured | 30 | parts. |
| by Toyobo Co., Ltd.) | | |
| To this were added | | |
| α-alumina (HIT55, manufactured by Sumitomo Chemical Co., Ltd.) | 10 | parts |
| carbon black (#50, manufactured by Asahi Carbon Co., Ltd.) | 3 | parts, |
| and | | |
| MEK/toluene = 1/1 | 200 | parts, |
| and the mixture was dispersed in a sand mill for 120 minutes. | | |
| To this were added | | |
| a 30% MEK/toluene = 1/1 solution of a polyisocyanate (Coronate 3041, | 15 | parts |
| manufactured by Nippon Polyurethane Industry Co., Ltd.) | | |
| stearic acid | 1 | part |
| myristic acid | 1 | part |
| isohexadecyl stearate | 3 | parts, |
| and | | |
| MEK | 100 | parts, |

and after stirring the mixture for a further 20 minutes, it was filtered using a filter having an average pore size of 1 μm to give a magnetic layer coating solution.

### Preparation of Non-Magnetic Layer Coating Solution

| | | |
|---|---|---|
| 85 parts of acicular α-iron oxide (major axis length 100 nm; alumina surface | 30 | parts, and |
| treatment layer; BET specific surface area 52 m²/g; pH 9.4) and 15 parts of carbon | | |
| black (Ketjen Black EC, manufactured by Ketjen Black International) were ground | | |
| in an open kneader for 10 minutes, and then kneaded for 60 minutes with | | |
| a 30% cyclohexanone solution of a vinyl chloride-based copolymer (MR110, | | |
| manufactured by Nippon Zeon Corporation) | | |
| a 30% MEK/toluene = 1/1 solution of a polyurethane resin (UR8200, manufactured | 30 | parts. |
| by Toyobo Co., Ltd.) | | |
| Subsequently, | | |
| MEK/cyclohexanone = 6/4 | 200 | parts |
| was added, and the mixture was dispersed in a sand mill for 120 minutes. To this | | |
| were added | | |
| a 30% MEK/toluene = 1/1 solution of a polyisocyanate (Coronate 3041, | 15 | parts |
| manufactured by Nippon Polyurethane Industry Co., Ltd.) | | |
| stearic acid | 1 | part |
| myristic acid | 1 | part |
| isooctyl stearate | 3 | parts, |
| and | | |
| MEK | 50 | parts, |

and after stirring the mixture for a further 20 minutes, it was filtered using a filter having an average pore size of 1 μm to give a non-magnetic layer coating solution.

The surface of a polyethylene naphthalate support (7 μm thick, center line average surface roughness Ra 6.2 nm) was coated by means of a wire-wound bar with a liquid mixture for a radiation-cured layer so that the dry thickness would be 0.5 μm, then dried at 100° C. for 90 sec., and cured by irradiation with an electron beam at an acceleration voltage of 100 kV so as to give an absorbed dose of 20 kGy (gray) under an atmosphere having an oxygen concentration of 4%.

Subsequently, using reverse roll simultaneous multilayer coating, the non-magnetic coating solution was applied on top of the radiation-cured layer and the magnetic coating solution was applied on top of the non-magnetic coating solution so that the dry thicknesses would be 1.0 μm and 0.1 μm respectively. Before the magnetic coating solution had dried, it was subjected to magnetic field alignment using a 5,000 G Co magnet and a 4,000 G solenoid magnet, the solvent was dried off, and the coating was then subjected to a calender treatment employing a metal roll-metal roll-metal roll-metal roll-metal roll-metal roll-metal roll combination (speed 100 m/min, line pressure 300 kg/cm, temperature 90° C.) and further to a thermal treatment at 50° C. for 7 days, and then slit to a width of 3.8 mm.

### Example 2 to Example 7

The procedure of Example 1 was repeated except that compound (T-1) of Example 1 was changed to compounds (T-2) to (T-7).

### (T-2) 1,4-butanediol dithioglycolate (difunctional)

### (T-3) pentaerythritol tetrakis(3-mercaptopropionate) (tetrafunctional)

### (T-4) 1,6-hexanedithiol (difunctional)

### (T-5) tris(2-hydroxyethyl) tri(3-mercaptopropionate) isocyanurate (trifunctional)

### (T-6) dipentaerythritol hexa(3-mercaptopropionate) (hexafunctional)

### (T-7) 4-methoxybutyl 3-mercaptopropionate (monofunctional)

### Example 8 to Example 23

The procedure was repeated except that the conditions shown in Table 1 were used.

### Comparative Example 1

The procedure of Example 1 was repeated except that the radiation-cured layer was not employed, and the thickness of the non-magnetic layer was changed from 1.0 μm to 1.5 μm.

### Comparative Example 2

The procedure of Example 1 was repeated except that compound (T-1) forming the radiation-cured layer was not employed, and all the monomer was 1,4-butanediol diacrylate.

### Comparative Example 3

The procedure of Example 1 was repeated except that all the radiation-cured layer was compound (T-1).

### Measurement Methods

### (1) Measurement of Thickness of Radiation-Cured Layer

5 sections of magnetic recording medium were prepared, the thickness of the radiation-cured layer in each section was measured using a transmission electron microscope (TEM), and an average value thereof was calculated and defined as the thickness of the radiation-cured layer.

### (2) Amount of Residual Monomer

A polyethylene naphthalate support was coated with a liquid mixture for a radiation-cured layer, then dried, and cured by exposure to radiation, thus giving a sample of the radiation-cured layer. Uncured monomer contained in the sample thus obtained was extracted into methyl ethyl ketone solvent at 40° C. for 2 hours. The monomer thus extracted was quantitatively analyzed using high performance liquid chromatography, and calculated as an amount of residual monomer (wt %) in 100 parts of the solids content of the radiation-cured layer.

### (3) Magnetic Layer Surface Roughness Ra

A center line average surface roughness Ra was measured by an optical interference method using a digital optical profiler (manufactured by Wyko Corporation) under conditions of a cutoff value of 0.25 mm.

### (4) Coefficient of Friction

Measurement of the coefficient of friction was carried out by sliding repeatedly for 10 passes at 14 mm/sec in an environment of 23° C. and 50% RH while the surface of the magnetic layer was made to contact an SUS420 member with a load of 50 g, and the coefficient of friction during the tenth pass was measured.

### (5) Adhesion

Double-sided adhesive tape was affixed to a glass plate, a tape sample was affixed thereto so that the magnetic layer side was in contact with the adhesive tape and peeled off by a 180° peel-off method, and the peel strength was measured using a spring scale.

### (6) Electromagnetic Conversion Characteristics

A single frequency signal at 4.7 MHz was recorded at an optimum recording current using a DDS3 drive, and the playback output thereof was measured and expressed as a relative value where the playback output of Comparative Example 1 was 0 dB.

### (7) Error Count

One 90 m long track was played back using the above-mentioned magnetic recording/playback system, and the number of times an error occurred was measured, defining an output fall of 35% or greater for a length of 4 bits or greater as a signal defect.

### (8) Transport Durability

Head contamination was inspected after repeating 1,000 passes of a 1 minute length of a tape in the DDS3 drive of (6) above at 40° C. and 30% RH; when there was no contamination, the result was evaluated as A, when there was slight contamination the result was evaluated as B, and when there was contamination the result was evaluated as C. After transport, the tape edge was inspected; when cracks were seen to have occurred the result was evaluated as B, when the magnetic layer was lost from the cracked part the result was evaluated as C, and when there were no cracks and no loss the result was evaluated as A.

### (9) Storage Stability

A tape that had been stored for one week in an environment of 60° C. and 90% RH was transported under the same conditions as above, and head contamination was inspected; when there was no contamination, the result was evaluated as A, when there was slight contamination the result was evaluated as B, and when there was contamination the result was evaluated as C.

The evaluation results for Examples 1 to 23 and Comparative Examples 1 to 3 are shown in Table 1 below. The radiation curing monomers are abbreviated as follows. BDDA denotes 1,4-butanediol diacrylate, TMTA denotes trimethylolpropane triacrylate, PETA denotes pentaerythritol tetraacrylate, EBPA denotes 2-ethyl-2-butyl-1,3-propanediol diacrylate, UR denotes a urethane diacrylate formed by condensation of trimethylhexamethylene diisocyanate and hydroxyethyl acrylate (Ebecryl 4858, manufactured by Daicel-Cytec Company Ltd.), and TCDA denotes tricyclodecanedimethanol diacrylate (DCP-A, manufactured by Kyoeisha Chemical Co., Ltd.).

TABLE 1

| | Chain | | Radiation | | | Radiation-cured | | Non- | | |
|---|---|---|---|---|---|---|---|---|---|---|
| | transfer | | curing | | Oxygen | layer | | magnetic | Magnetic layer | |
| | agent | | monomer | | conc. when | | Residual | layer | | Surface |
| | | Parts | | Parts | exposed to | Thickness | monomer | Thickness | Thickness | roughness |
| | Type | (solids) | Type | (solids) | radiation [%] | [μm] | [wt %] | [μm] | [μm] | Ra [nm] |
| Ex. 1 | T-1 | 20 | BDDA | 80 | 4% | 0.5 | 1.8 | 1 | 0.1 | 1.8 |
| Ex. 2 | T-2 | 20 | BDDA | 80 | 4% | 0.5 | 2.4 | 1 | 0.1 | 1.9 |
| Ex. 3 | T-3 | 20 | BDDA | 80 | 4% | 0.5 | 1.7 | 1 | 0.1 | 2 |
| Ex. 4 | T-4 | 20 | BDDA | 80 | 4% | 0.5 | 2.2 | 1 | 0.1 | 1.9 |
| Ex. 5 | T-5 | 20 | BDDA | 80 | 4% | 0.5 | 1.9 | 1 | 0.1 | 2.1 |
| Ex. 6 | T-6 | 20 | BDDA | 80 | 4% | 0.5 | 1.2 | 1 | 0.1 | 2.3 |
| Ex. 7 | T-7 | 20 | BDDA | 80 | 4% | 0.5 | 7.1 | 1 | 0.1 | 2 |
| Ex. 8 | T-1 | 20 | TMTA | 80 | 4% | 0.5 | 1.6 | 1 | 0.1 | 2 |
| Ex. 9 | T-1 | 20 | PETA | 80 | 4% | 0.5 | 1.4 | 1 | 0.1 | 2.1 |
| Ex. 10 | T-1 | 20 | EBPA | 80 | 4% | 0.5 | 1.1 | 1 | 0.1 | 1.8 |
| Ex. 11 | T-1 | 20 | UR | 80 | 4% | 0.5 | 0.9 | 1 | 0.1 | 2.1 |
| Ex. 12 | T-1 | 20 | TCDA | 80 | 4% | 0.5 | 1.9 | 1 | 0.1 | 1.8 |
| Ex. 13 | T-1 | 2 | BDDA | 98 | 4% | 0.5 | 6.3 | 1 | 0.1 | 1.9 |
| Ex. 14 | T-1 | 5 | BDDA | 95 | 4% | 0.5 | 3.6 | 1 | 0.1 | 2.1 |
| Ex. 15 | T-1 | 10 | BDDA | 90 | 4% | 0.5 | 2.3 | 1 | 0.1 | 2.1 |
| Ex. 16 | T-1 | 30 | BDDA | 70 | 4% | 0.5 | 2.6 | 1 | 0.1 | 1.9 |
| Ex. 17 | T-1 | 50 | BDDA | 50 | 4% | 0.5 | 6.9 | 1 | 0.1 | 2.5 |
| Ex. 18 | T-1 | 20 | BDDA | 80 | 4% | 0.5 | 1.8 | — | 0.1 | 1.6 |
| Ex. 19 | T-1 | 20 | BDDA | 80 | 4% | 0.3 | 2.1 | 1 | 0.1 | 2.4 |
| Ex. 20 | T-1 | 20 | BDDA | 80 | 4% | 0.8 | 1.8 | 1 | 0.1 | 1.7 |
| Ex. 21 | T-1 | 20 | BDDA | 80 | 4% | 1.4 | 1.6 | 1 | 0.1 | 1.7 |
| Ex. 22 | T-1 | 20 | BDDA | 80 | 12% | 0.5 | 2.6 | 1 | 0.1 | 2 |
| Ex. 23 | T-1 | 20 | BDDA | 80 | 21% | 0.5 | 4.8 | 1 | 0.1 | 2.3 |
| | | | | | (atmospheric) | | | | | |

| Comp. Ex. 1 | — | — | | — | | | 1.5 | 0.1 | 3.4 |
|---|---|---|---|---|---|---|---|---|---|
| Comp. Ex. 2 | — | BDDA | 100 | 4% | 0.5 | 15.5 | 1 | 0.1 | 1.8 |

| | | | | | |
|---|---|---|---|---|---|
| Comp. Ex. 3 | T-1 | 100 | — | 4% | (Did not cure after exposure to radiation, |
| | | | | | could not be evaluated.) |

| | | | Electro- | | | | Storage |
|---|---|---|---|---|---|---|---|
| | | | magnetic | | | | stability |
| | | | conversion | | Transport | | (head |
| | | Coefficient | characteristics | Error | durability | | contamination |
| | Adhesion | of friction | C/N | count | Head | Edge | after |
| | [gf] | [—] | [dB] | [times] | contamination | damage | storage) |
| Ex. 1 | 210 | 0.26 | 1.9 | 32 | A | A | A |
| Ex. 2 | 200 | 0.28 | 1.6 | 34 | A | A | A |
| Ex. 3 | 205 | 0.26 | 1.9 | 30 | A | A | A |
| Ex. 4 | 190 | 0.27 | 1.6 | 33 | A | A | A |
| Ex. 5 | 210 | 0.26 | 1.8 | 32 | A | A | A |
| Ex. 6 | 210 | 0.25 | 1.4 | 35 | A | A | A |
| Ex. 7 | 180 | 0.32 | 1.3 | 37 | B | A | B |
| Ex. 8 | 200 | 0.26 | 2.1 | 28 | A | A | A |
| Ex. 9 | 200 | 0.25 | 2.3 | 33 | A | A | A |
| Ex. 10 | 205 | 0.26 | 1.7 | 33 | A | A | A |
| Ex. 11 | 210 | 0.27 | 2.2 | 29 | A | A | A |
| Ex. 12 | 180 | 0.26 | 1.7 | 32 | A | A | A |
| Ex. 13 | 170 | 0.31 | 1 | 45 | B | A | B |
| Ex. 14 | 175 | 0.28 | 1.5 | 36 | A | A | A |
| Ex. 15 | 180 | 0.27 | 1.7 | 34 | A | A | A |
| Ex. 16 | 210 | 0.27 | 1.4 | 38 | A | A | A |
| Ex. 17 | 180 | 0.29 | 1.2 | 41 | B | A | B |
| Ex. 18 | 200 | 0.28 | 2.1 | 30 | A | A | A |
| Ex. 19 | 210 | 0.25 | 1.8 | 34 | A | A | A |
| Ex. 20 | 170 | 0.27 | 1.9 | 31 | A | A | A |
| Ex. 21 | 150 | 0.28 | 2.1 | 28 | A | A | A |
| Ex. 22 | 200 | 0.27 | 1.9 | 34 | A | A | A |
| Ex. 23 | 180 | 0.28 | 1.6 | 41 | A | A | A |
| Comp. Ex. 1 | 200 | 0.25 | 0 | 72 | A | C | A |
| Comp. Ex. 2 | 150 | 0.34 | 0.6 | 330 | C | B | C |

| | |
|---|---|
| Comp. Ex. 3 | (Did not cure after exposure to radiation, could not be evaluated.) |

The magnetic recording medium of Example 1 showed a low amount of residual monomer after the radiation treatment in spite of the oxygen concentration being as high as 4%, which suggests that it was cured sufficiently; furthermore, since the surface smoothness was high, the electromagnetic conversion characteristics and error characteristics were excellent, the coefficient of friction was low, and the durability was also excellent.

The magnetic recording medium of Comparative Example 1, which did not comprise the radiation-cured layer, showed a high measured value for the surface roughness, edge damage occurred after the transport durability test, and the error count was not at a satisfactory level.

The magnetic recording medium of Comparative Example 2, which did not comprise the chain transfer agent, had a very high amount of residual monomer and a very high coefficient of friction, and as a result the error count, the transport durability, and the storage stability were poor.

The magnetic recording medium of Comparative Example 3, which did not comprise the radiation curing monomer, was not cured at all after radiation treatment, and it therefore could not be used as a magnetic recording medium.

The magnetic recording media of Examples 2 to 7, which comprised chain transfer agents (T-2) to (T-7) instead of (T-1), had a low amount of residual monomer after curing by radiation; furthermore, since the surface smoothness was high, the electromagnetic conversion characteristics and error characteristics were excellent, the coefficient of friction was low, and the durability was also excellent. Among them, the magnetic recording medium employing the monofunctional thiol (T-7) showed a tendency for the amount of residual monomer to increase, whereas there was a tendency for the amount of residual monomer to decrease as the number of thiol functional groups increased.

The magnetic recording media of Examples 8 to 12 were prepared by changing the radiation curing monomer BDDA of Example 1 to those shown in Table 1.

Even by changing the monomer, there were no great changes in terms of any of the surface smoothness, electromagnetic conversion characteristics, durability, storage stability, etc. of the magnetic recording media. In this way, it has been found that, even when the radiation curing monomer is changed, almost the same results are obtained.

The magnetic recording media of Example 13 to Example 17 were obtained by changing the proportion of chain transfer agent (T-1) used, as shown in Table 1. As a result of changing the proportion used, in all cases the amount of residual monomer in the radiation-cured layer was low, the surface smoothness of the magnetic recording medium was high, the electromagnetic conversion characteristics and the error characteristics were excellent, the coefficient of friction was low, and the durability was excellent. The amount of residual monomer changed according to the proportion of chain transfer agent (T-1) used; when it was 2 parts in 100 parts of the solids content of the radiation-cured layer and when it was 50 parts the amount of residual monomer increased, and as a result there was a tendency for the coefficient of friction to increase and for head contamination after the transport durability test and the storage stability to deteriorate.

The magnetic recording medium of Example 18, which did not employ a non-magnetic layer, showed a low amount of residual monomer and high surface smoothness after curing by radiation; the electromagnetic conversion characteristics and the error characteristics were therefore excellent, the coefficient of friction was low, and the durability was also excellent. Taking into account the results of Example 1, use of the non-magnetic layer as means for attaining the object of the present invention is optional.

The oxygen concentration when forming a radiation-cured layer by exposure to radiation does not greatly affect the amount of residual monomer, sufficient curing is possible in practice in the atmosphere (oxygen concentration about 21%), but for the object of reducing the amount of residual monomer the oxygen concentration is preferably low, more preferably no greater than 10%, and yet more preferably no greater than 5%.

When the thickness of the radiation-cured layer was 0.3 to 1.4 μm, good results were obtained. When the radiation-cured layer was not provided or its thickness was smaller, the surface roughness tended to increase; when its thickness was greater, the adhesion as a magnetic recording medium tended to deteriorate, and a preferred thickness for the radiation-cured layer is therefore 0.1 to 1.5 μm.

From the results above, the magnetic recording medium comprising, above a non-magnetic support, a radiation-cured layer cured by exposing a layer comprising a radiation curing monomer and a chain transfer agent to radiation had excellent smoothness, a low coefficient of friction, excellent electromagnetic conversion characteristics and error characteristics, and excellent transport durability and storage stability. Furthermore, a radiation-cured layer having a low amount of residual monomer was obtained under an atmosphere with a high oxygen concentration.

What is claimed is:

1. A magnetic recording medium comprising:
a non-magnetic support and, in order thereabove;
a radiation-cured layer cured by exposing a layer comprising a radiation curing monomer and a chain transfer agent to radiation; and
a magnetic layer comprising a ferromagnetic powder dispersed in a binder.

2. The magnetic recording medium according to claim 1, wherein the magnetic recording medium comprises, between the radiation-cured layer and the magnetic layer, a non-magnetic layer comprising a non-magnetic powder dispersed in a binder.

3. The magnetic recording medium according to claim 1, wherein the chain transfer agent is at least one compound selected from the group consisting of a thiol compound having at least one thiol group and a disulfide compound having at least one —S—S— bond.

4. The magnetic recording medium according to claim 1, wherein the chain transfer agent is a thiol compound having at least one thiol group.

5. The magnetic recording medium according to claim 1, wherein the chain transfer agent is a thiol compound having at least two thiol groups.

6. The magnetic recording medium according to claim 1, wherein the chain transfer agent is at least one polyfunctional thiol compound selected from the group consisting of trimethylolpropane tris(3-mercaptopropionate), 1,4-butanediol dithioglycolate, pentaerythritol tetrakis(3-mercaptopropionate), 1,6-hexanedithiol, tri(3-mercaptopropionic acid) tris(2-hydroxyethyl)isocyanurate, and dipentaerythritol hexa(3-mercaptopropionate).

7. The magnetic recording medium according to claim 1, wherein the chain transfer agent is contained at 2 to 50 wt % relative to the total solids content of the radiation-cured layer.

8. The magnetic recording medium according to claim 1, wherein the chain transfer agent is contained at 5 to 30 wt % relative to the total solids content of the radiation-cured layer.

9. The magnetic recording medium according to claim 1, wherein the radiation curing monomer is an ethylenically unsaturated monomer.

10. The magnetic recording medium according to claim 1, wherein the radiation curing monomer is an ethylenically unsaturated monomer having two or more radiation curing functional groups per molecule.

11. The magnetic recording medium according to claim 1, wherein the radiation curing monomer is a polyfunctional (meth)acrylate obtained by reacting a polyhydric alcohol with (meth)acrylic acid, and/or a polyfunctional urethane (meth)acrylate obtained by reacting a polyvalent isocyanate compound with hydroxyethyl (meth)acrylate.

12. The magnetic recording medium according to claim 1, wherein the radiation curing monomer is a polyfunctional acrylate obtained by reacting a polyhydric alcohol with acrylic acid, and/or a polyfunctional urethane acrylate obtained by condensing a polyvalent isocyanate compound and hydroxyethyl acrylate.

13. The magnetic recording medium according to claim 1, wherein the radiation curing monomer is at least one radiation curing monomer selected from the group consisting of 1,4-butanediol diacrylate, trimethylolpropane triacrylate, pentaerythritol tetraacrylate, 2-ethyl-2-butyl-1,3-propanediol diacrylate, tricyclodecanedimethanol diacrylate, and a urethane diacrylate obtained by condensing trimethylhexamethylene diisocyanate and hydroxyethyl (meth)acrylate.

14. The magnetic recording medium according to claim 1, wherein the radiation curing monomer is a urethane diacrylate obtained by condensing trimethylhexamethylene diisocyanate and hydroxyethyl acrylate.

15. The magnetic recording medium according to claim 1, wherein the exposure to radiation is exposure to an electron beam.

16. The magnetic recording medium according to claim 1, wherein the radiation-cured layer has a thickness of 0.1 to 1.5 μm.

17. The magnetic recording medium according to claim 1, wherein the non-magnetic support is a non-magnetic support selected from the group consisting of polyethylene terephthalate, polyethylene naphthalate, polyamide, polyamideimide, and an aromatic polyamide.

18. The magnetic recording medium according to claim 1, wherein the non-magnetic support is polyethylene naphthalate.
